(19) United States
(12) Patent Application Publication
(10) Pub. No.: US 2005/0273668 A1
(43) Pub. Date: Dec. 8, 2005

(54) Dynamic and distributed managed edge computing (MEC) framework

(76) Inventor: Richard Manning, Alpharetta, GA (US)

Correspondence Address: HOGAN & HARTSON LLP, ONE TABOR CENTER, SUITE 1500, 1200 SEVENTEEN ST., DENVER, CO, 80202, US

(21) Appl. No.: 10/850,291

(22) Filed: May 20, 2004

(51) Int. Cl. G06F 11/00

(52) U.S. Cl. 714/39; 714/1

(57) ABSTRACT

A method and system for monitoring and managing distributed services in a network. The method involves instantiating a managed peer, a context instance, and a managed service at an edge computing node. The managed peer, the context instance, and the managed service are instrumented and registered with a monitoring server. The method continues with establishing a monitor for the managed peer, the context instance, and the managed service and monitoring during runtime one or more values of the monitor. The method includes modifying the managed peer, the context, and/or the managed service based on the values of the monitors. The method includes caching advertisements of services available from other managed peers in the context, searching the cache for available services or resources, and requesting one or more of the advertised services from managed peers local or remote to the edge computing node.

### BACKGROUND OF THE INVENTION

1. Field of the Invention

The present invention relates, in general, to peer-to-peer (P2P) computing and edge computing (EC), and, more particularly, to a method and system for dynamically managing and monitoring peer devices distributed in an edge computing environment.

2. Relevant Background

The computer industry continues to move to open standards-based computing solutions and low cost deployment platforms that more effectively utilize idle resources. Within this trend, a renewed interest has emerged in the complementary technologies of peer-to-peer (P2P) computing and edge computing (EC). P2P computing involves an application or network solution that supports the direct exchange of resources between computers without relying on a common or centralized file server. Once P2P computing software is installed on a computing device, each device becomes a “peer” that can act as both a client and a server, which reduces processing and storage on centralized servers, improves communication latencies as peers search for nearest resources, and improves infrastructure resiliency against failure by providing redundancy of resources over many peer devices. Edge computing, as the name implies, involves pushing data and computing power away from a centralized point to the logical extremes or edges of a network. Edge computing is useful for reducing the data traffic in a network, which is important as the computer industry addresses the fact that bandwidth within networks is not unlimited or free. Edge computing also removes a potential bottleneck or point of failure at the core of the network and improves security as data coming into a network typically passes through firewalls and other security devices sooner or at the edges of the network.

The growing trend is toward relatively large numbers of low-cost commodity network appliances or nodes. Each network node typically has limited computing power, e.g., limited processors, processor speed, memory, storage, network bandwidth, and the like, which is compensated by the large number of network nodes. Some edge computing networks are even designed to include desktop computers and off-load work to idle or underutilized systems. One problem with edge computing systems is that as the number of the network nodes increases, the complexity of the installation also increases. Many nodes are often configured with excess capacity to support estimated peak loads, but these computing resources are underutilized for large percentages of service life of the node. As a result, there is a growing demand for effective management of the network resources and utilization of networked resources and nodes to obtain more of the performance, functional, and cost benefits promised by edge computing.

P2P systems also present unique operational and management problems. In a P2P system, computing nodes called “peers” are independently executed and managed entities. Peers are able to form loose, ad hoc associations with other peers for some mutual task and have the ability to rapidly disassociate. As a result, P2P systems are non-deterministic and there is no guarantee that a peer and its resources will be available at any given point in time or even remain available during the performance of a task. Managing peers and their resources is difficult as each peer is simply an independent software component that collaborates on an as-needed basis, and it is often difficult to balance the ratio between peers that are consuming resources and peers that are offering resources on a network.

Typically, P2P systems and edge computing systems have been implemented separately with any management challenges being addressed independently on each device. Hence, there remains a need for an improved method and system that leverages the capabilities of P2P systems and technology within an edge computing environment. Such a method and system should be based on open edge computing standards and provide improved management and monitoring of the elements of the P2P systems to create a simple and extensible service-oriented environment. Such a method and system would preferably provide a managed, distributed services solution for edge computing environments applicable to various domains. The method and system also preferably would support dynamic configuration and reconfiguration of the system or its elements autonomously and/or with human interaction.

### SUMMARY OF THE INVENTION

The present invention addresses the above problems by providing a managed edge computing (MEC) method and system. The MEC method and system of the invention functions to effectively combine the open standards and management technology of P2P computing with edge computing to provide a powerful, lightweight extensible technology foundation for managed edge computing. The MEC method and system is configured to be a service-oriented architecture (SOA) approach to edge computing based on open standards to provide mobile, web, and other services on network nodes or peers that are instrumented for effective monitoring and management. For example, but not as a limitation, the MEC method and system utilizes and integrates an open network computing platform and protocols designed for P2P computing (such as JXTA technology) with remote management tools and mechanisms (such as Java Management Extensions (JMX)). The MEC method and system functions to provide dynamic distributed mobile services on peer nodes in a network with each node being instrumented with components that facilitate remote management of the network resources through dynamic monitoring, metering, and configuring of the services. The MEC method and system is adapted for dynamic discovery of network resources, for dynamic association of peers, for dynamic binding of communication channels between the peers, and for dynamic provisioning (i.e., downloading, installing, and executing) of services on network nodes.

More particularly, a method is provided for monitoring and managing distributed services in a network. The method involves instantiating a managed peer, a context instance, and a managed service at an edge computing node of the network. The managed peer, the context instance, and the managed service are instrumented and registered with a monitoring server. The method continues with establishing a monitor for the managed peer, the context instance, and the managed service and monitoring during runtime one or more values of the monitor. The monitor may use listeners for monitoring the runtime state of these elements and reporting when the values is outside acceptable bounds, which are set based on a set of policies. The method further includes modifying the managed peer, the context, and/or the managed service based on the value of the monitor corresponding to the element(s) modified. The method may also include caching advertisements of services available from other managed peers in the context, searching the cache (such as based on changes in the monitored values or needs of the edge computing node) for available services or resources, and requesting one or more of the advertised services. The edge computing node is a code source and code requester, and hence, the method further comprises operating a service locater to locate a managed service remote to the node and loading the located managed service with a service loader based on the set of policies. The method also includes instantiating a code server, receiving a provisioning request for the managed service provided by the managed peer and delivering code corresponding to the managed service to the requesting peer.

### BRIEF DESCRIPTION OF THE DRAWINGS

FIG. 1 illustrates in block form basic components of a JXTA system or network;

FIG. 2 illustrates in simplified block diagram form an edge computing system according to the invention in which edge computing (EC) nodes include a managed edge computing (MEC) component;

FIG. 3 illustrates an exemplary architecture or MEC framework of an MEC component such as would be included on each EC node of an edge computing system as shown in FIG. 1;

FIG. 4 illustrates another exemplary architecture or MEC framework of an MEC component showing added monitoring and management devices, such as with the integration of JMX components and/or technology on the MEC framework of FIG. 3;

FIG. 5 illustrates another architecture of an MEC component useful for providing mobile agents such as on the EC nodes of the system of FIG. 1, and the component utilizes the simple intelligent agent management (SIAM) horizontal overlay of the present invention; and

FIG. 6 illustrates yet another architecture of an MEC component useful for presenting web services via an edge computing network, such as that shown in FIG. 1, and the MEC component shown is configured according to the virtual web services (VWS) horizontal overlay of the present invention.

### DETAILED DESCRIPTION OF THE PREFERRED EMBODIMENTS

The present invention is directed to a managed edge computing (MEC) method and system that provides a lightweight, managed P2P framework for edge computing. The MEC framework of the invention defines a set of components that encapsulate and integrate mobile services with monitoring and management tools, e.g., a JXTA-based architecture with JMX capabilities and components. Application components defined as domain specific elements are generally shielded from much of the direct knowledge of the MEC framework, as configuration, management, and monitoring may be set for each domain specific context through a policy mechanism. MEC framework elements are able to analyze their runtime environment context and in response, make autonomic adjustments within the constraints of a policy enforced by the policy mechanism.

Additionally, the MEC framework provides a foundation for numerous specific embodiments that extend upon the framework and that may be labeled “horizontal overlays.” One horizontal overlay uses the MEC framework as a basis to provide a deployment environment for mobile, intelligent software agents to enable the creation of multi-agent systems. This overlay is called Simple Intelligent Agent Management (SIAM) or a SIAM overlay or SIAM system and extends the basic capabilities of the MEC framework to allow domain application component services to interact with the MEC framework more directly, thereby enabling SIAM services to take on the characteristics of autonomous mobile intelligent software agents. Another example of a horizontal overlay according to the invention is the Virtual Web Services (VWS) overlay that uses the MEC framework to provide a deployment environment for web services. The VWS overlay exposes one or more of the MEC framework services as web services, e.g., as standard WUS (WSDL, UDDI, SOAP) web services. These exemplary horizontal overlays (or extensions of the MEC framework) are complimentary and may be combined in a number of ways in various computing systems and environments. For example, mobile software agents of the invention can be exposed as standard web services or inversely, web services can be implemented as mobile software agents.

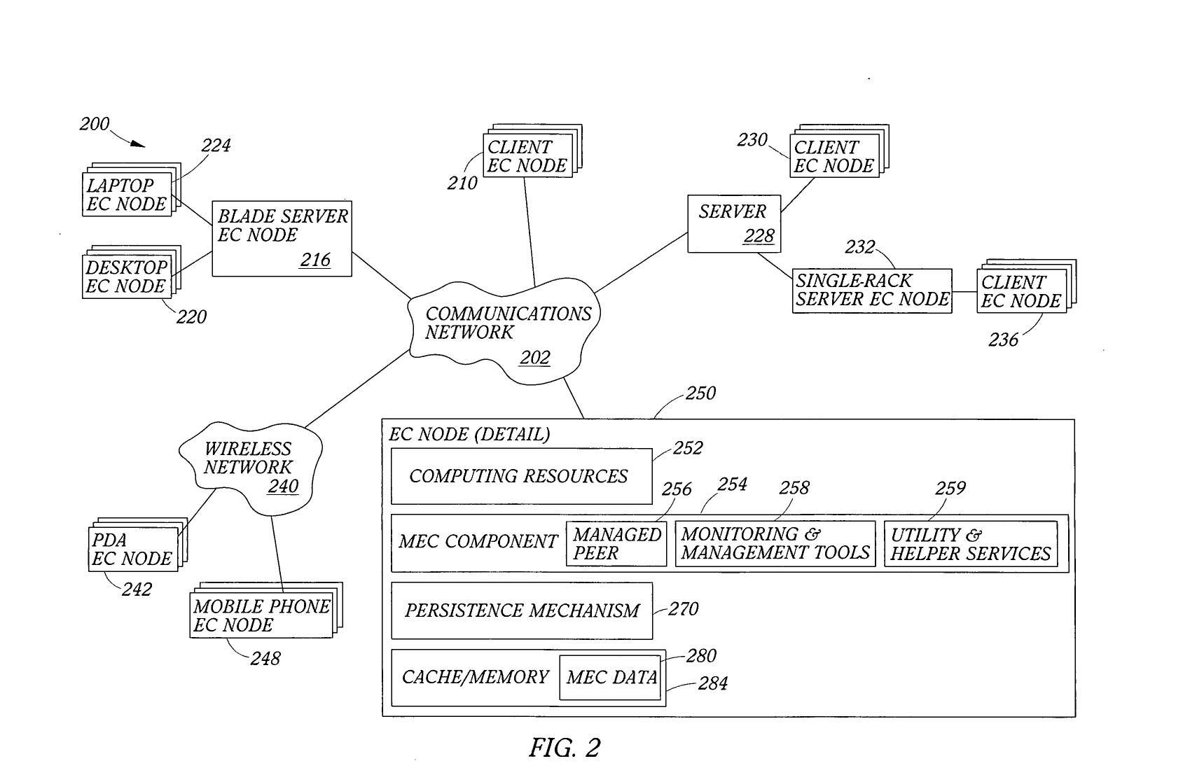

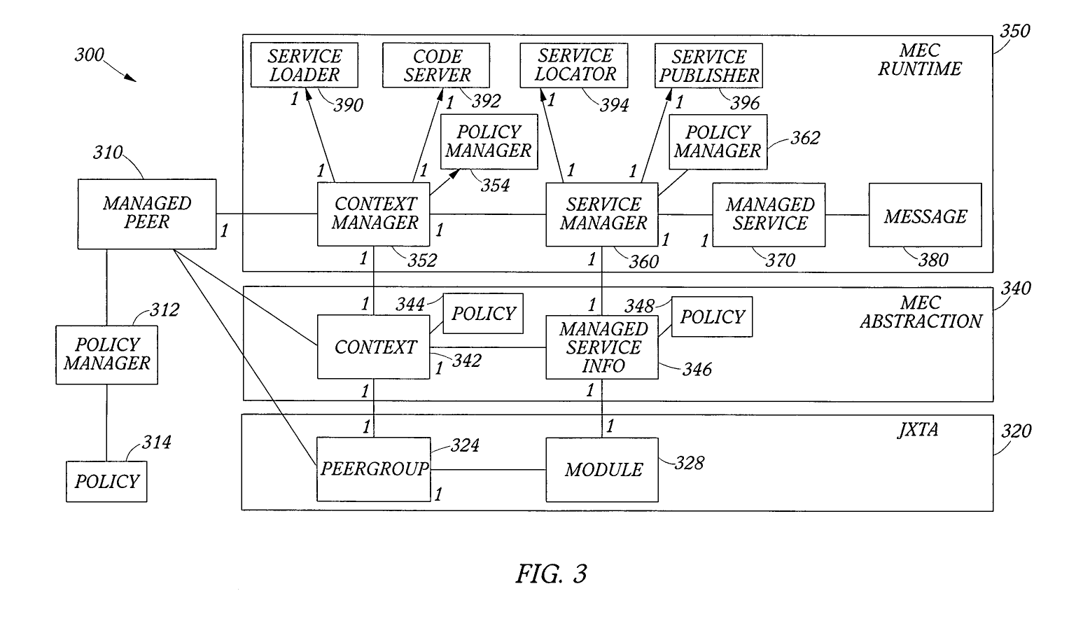

The following description begins with an overview of several features of the MEC framework and its capabilities arising from these features. Then, an overview of JXTA and JMX are provided as these two technologies are used to implement several embodiments of the invention and a brief overview may be useful in fully understanding the invention. An edge computing network implementing the P2P and monitoring and management functions is presented in FIG. 2. Implementations of an MEC framework, a SIAM overlay, and a VWS overlay are then presented with reference to FIGS. 3-5.

The MEC framework generally provides a set of fundamental or base capabilities that facilitate improved edge computing. These features include dynamic code mobility, asynchronous message-oriented communications, management, monitoring, policy driven control, context awareness, self awareness, self organization, and autonomic behavior. Dynamic code mobility is provided by effectively making every node or peer in the system capable of distributing code, which is known as “code serving.” Technologies such as Java2 Platform provide the basic ability to distribute intermediate code, known as byte code, over network protocols such as HTTP through the serialization mechanism. JXTA provides the basic ability to advertise the availability of code for distribution over HTTP. Code repositories such as web servers can provide code to a basic JXTA system. However, the MEC framework extends and/or overloads these capabilities to make every node or peer a code server while each node or peer is also able to obtain code from any other known node or peer or be a “code requester.” In addition, the MEC framework uses this bi-directional code distribution capability to provide mobile code and data. For example, JXTA provides a construct known as Codat that encapsulates both code and data (including operational states). In the context of the MEC framework, Codats essentially become mobile software agents capable of migrating and replicating to any node in the system.

The MEC framework provides location hiding by improving or modifying the asynchronous communication model, such as that provided by JXTA, which allows for loosely coupled application designs for a service oriented solution. More particularly, domain specific services within the MEC framework send messages to a named target in a location agnostic manner. Contrary to the design goals of many other distributed systems, the MEC framework with its goal of simplicity insulates domain application developers from direct knowledge of the location of a message target service. Message senders send a message to a message receiver target that may be remote or local to the sender. The MEC framework handles the actual message delivery. In addition, the MEC framework provides a remote interaction policy. For example, a service or sender that is communicating with a remote service or receiver a number of times in a time period can initiate a dynamic local instantiation of the message target service or a migrate/replicate of itself or the remote service. The dynamic distribution occurs within the MEC framework not within the domain application domain development.

As with JXTA, the basic communication in the MEC framework is unicast and unreliable. The MEC framework also allows the use of unicast reliable and unicast secure asynchronous communication models. Policies within the MEC framework define the reliability parameters for communications. Further, the MEC framework also generally supports synchronous forms of messaging. While the MEC framework (and the horizontal overlays discussed herein) use basic messaging that is asynchronous, it should be understood that synchronous, reliable, and/or secure reliable messaging is also supported in some embodiments of the MEC framework. More particularly, all of the messaging models supported by JXTA can be exposed and used in the MEC framework (and the horizontal overlays).

The MEC framework elements are instrumented for runtime monitoring and modification of most system aspects including policies and configurations, e.g., with JMX-based monitoring and management features. In addition, the management capabilities of the MEC framework provide the ability to dynamically introduce new domain elements, modify existing domain elements and remove existing domain elements. Management in the framework is a primary catalyst for dynamic distribution of elements within the system. Domain application services are free to provide additional domain specific instrumentation that will be exposed to the framework management components.

Monitoring within the MEC framework allows system state information to be collected and analyzed. The analysis of the information allows the MEC framework or a system incorporating such a framework to dynamically and autonomically tune operational parameters consistent with applicable policies. The monitored information is a primary source of information that enables higher order behaviors such as context awareness, self awareness, and self organization.

The policy driven feature of the MEC framework refers to system control being provided by policy enforcement. Policies in the framework control the configuration of framework elements as well as interactions between those elements. Policies may be applicable system wide, context wide, and intra-component. Policy enforcement in the framework utilizes the information analysis gathered via the monitoring components and makes adjustments to the components or services via the management components.

Context awareness within the MEC framework is the ability for each component or peer within an edge computing environment to perform monitoring and analysis of itself within its current location and/or context. In other words, each component or peer has awareness of the available resources and constraints in effect within its context. A corollary feature is self awareness that allows a component in the MEC framework to understand and interpret its own state in a meaningful way within the distributed runtime environment. Components analyze themselves and their context as a way to plan, prioritize, and execute actions within the constraints of the policies. Building upon these features, MEC framework components (e.g., services) self organize themselves as the number and location of service instances in the system will be dynamically determined by the aggregation of their individual self analysis, current policies, and the changing demands on the system implementing the MEC framework. For example, a single instance of a service component may be deployed on a single node. Over time, the original instance may physically move to other locations within the system and/or additional instances of the service may be created, copied, and/or migrated automatically using system state and policies without the need for direct human administration.

Autonomic behavior is the exhibition of apparent autonomous actions, including proactive and reactive actions, of framework components and application domain components within the system. In addition, a degree of emergent behavior is anticipated as deployed systems using the MEC framework grow, shrink, change, and age. It is expected that the system and its human administrators will be able to analyze autonomic behaviors, emergent behaviors, and dynamic distribution patterns (as well as the effects of modifying resources, constraints, and policies) to develop runtime system models.

The MEC framework preferably is based on open and community standards. For example, the embodiments of the invention discussed below are explained utilizing Java, JMX, and JXTA. Java, JMX, and JXTA are open source technologies and the Java and JMX technology standards are managed by the Java Community Process. Prior to more fully discussing the details of the invention, it may be useful to provide a basic discussion of P2P computing systems, JXTA, and JMX.

JXTA and P2P computing are well suited to edge computing (EC). This is due in large part to the nature of P2P computing which has a number of inherent characteristics. P2P systems are based on a non-deterministic model with nodes coming and going and demand increasing and decreasing. P2P systems provide massive scalability, and performance tends to increase in direct proportion to the number of nodes (peers). P2P systems have high distribution of resources with few if any single points of failure. P2P systems are adaptable with dynamic discovery of network resources. Direct connection of peers is provided for a more cooperative, social computing style. P2P systems are resilient due to replication of resources and interchangeability of peers. The relationships among peers can be dynamic, ad hoc, and transient. The characteristics of P2P networks can be supported by, and map directly to, edge computing architectures. The edge computing architecture has a large number of low end, low cost, low computing power, network appliance class hardware nodes. If each of these EC nodes hosts a peer, the EC system forms a natural P2P network (see, FIG. 2 for example).

JXTA provides to P2P computing a distillation or abstraction of the fundamental behaviors of P2P systems. The result is a set of open, XML-based protocols for creating P2P style networks, computing applications, and services. While some embodiments of the MEC framework use Java, JXTA does not rely on Java. Since JXTA is an open, XML-based set of protocols, it is hardware platform, operating system, programming language, and network technology independent.

Basically, JXTA provides three main capabilities for use in the MEC framework. Network resources can be discovered, discovered network resources can be associated, and discovered network resources can communicate. These computing or network resources may take many forms. In JXTA, network resources can be software, content, devices, hardware, or anything that can be described in the JXTA system and may be available on one or more components that are available on a network such as processors, I/O devices, software applications, static and non-static memory. Network resources are described using JXTA advertisements. Advertisements are XML documents that provide information regarding the advertised network resources. To make the resource available to the JXTA network or system, the advertisement is published. As will become clear, every network resource in the JXTA-based MEC framework or network is described by an advertisement, which includes basic components or network resources of JXTA such as peers, peer groups, pipes, and services.

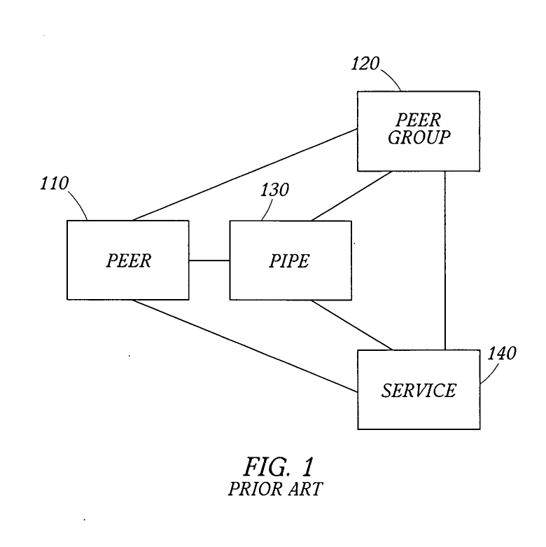

FIG. 1 shows basic network resources and their relationships as provided by JXTA. Generally, peers are the P2P network's nodes, as is true for the MEC framework or MEC framework system (see, FIG. 2). For JXTA a peer 110 is any device that implements one or more of the JXTA protocols. Peers operate independently and can dynamically discover available JXTA network resources such as other peers, content, peer groups, and the like. Peer groups 120 provide scope domains that enable dynamic self organization of peers 110. Peer groups 120 provide association of network resources. When a network resource's advertisement is published, it is published in the context of a peer group 120. To associate with a peer group 120, a peer 110 first joins the peer group 120 and then, the resources of the peer group 120 or some limited subset of the resources are available to the peer 110.

To communicate with peer group's 110 network resources, JXTA uses pipes 130. Pipes 130 are network resources, and thus, have advertisements. Pipes 130 provide the method of communicating between two or more network resources. Sets of functionality can be combined into a JXTA network resource called a service 140. A service 140 has a hierarchical set of advertisements that describe the details of the service 140 to the JXTA network. These are known as module advertisements and provide JXTA peers 110 with the ability to dynamically discover, download, install, and execute services 140 on the peers 110 themselves or interact with services 140 provided by other peers (not shown) in the peer group 120.

As FIG. 1 implies, peers 110 can belong to, i.e., participate in, one or more peer groups 120 and peer groups typically have more than one peer 110. Peers 110 can have one or more pipes 130, and pipes 130 can be advertised by more than one peer 110. In JXTA, the advertisement “advertises” the existence of the resource within a context scope, but an instance is the actual resource. A resource instance may have one advertisement, which is published in many contexts, that refers to a single resource instance. Alternatively, many resource instances may have one advertisement that each resource publishes in a single context or many contexts. Peers 110 can have one or more services 140, and services 140 can belong to more than one peer 110. This can be thought of as a redundancy mechanism provided by JXTA, as it does not matter which pipe 130 or service 140 instance a peer 110 uses as long as the peer 110 is able to find one to use.

Services 140 can be advertised in one or more peer groups 120, e.g., the same instance of the service 140 with the same advertisement that is published in more than one peer group 120. Additionally, peer groups 120 can have services 140 that are unique to the peer group 120 or replace a service instance 140 using the same advertisement. It is worth noting that both peers 110 and peer groups 120 can provide services 140. A peer service is an instance of service 140 that is provided by a single peer 110. Many peers 110 can provide the service 140 but each advertises its own instance of the service 140. Peer group services are services that are advertised as part of the peer group 120 advertisement. The default behavior in JXTA is that every member peer 110 of a peer group 120 provides an instance of all the peer group services. In addition to the core components of JXTA shown in FIG. 1, JXTA also provides some support services for monitoring and metering network resources.

While JXTA provides a basis for edge computing systems, the use of JXTA for edge computing configuration requires additional, potentially extensive, custom design and coding. The MEC framework of the present invention makes the capabilities of JXTA easier to use and extends these capabilities to provide a richer solution for edge computing environments. As will become clear, some of the MEC framework extensions of the JXTA teachings comprise interfaces and software components for network resource definition, distribution, and management. In some embodiments, these extensions arise from and build upon an integration of JXTA and JMX.

Generally, the Java Management Extensions (JMX) are adapted to provide instrumentation, management, and monitoring capabilities to software systems. JMX instrumentation is the task of exposing an interface that allows a management system to identify, interrogate, monitor, and affect a component. This is known as the JMX Instrumentation Level, and instrumented components are labeled or known as “MBeans.” Instrumented components are registered and managed at a JMX Agent Level. The Agent Level comprises an MBeanServer and a set of agent services. The MBeanServer provides two main capabilities. First, it is a registry for MBeans. Second, it is a communications broker between MBeans (e.g., inter-MBean communications) and between MBeans and management applications. The MBeanServer is also an MBean, which means it is also instrumented. The additional services of the Agent Level include an MLet Service, monitoring services, a timer service, and a relation service. In the MEC framework or in MEC framework systems, these services are leveraged, integrated, and extended to provide the unique edge computing solution of the present invention.

FIG. 2 illustrates one embodiment of an edge computing (EC) system or network 200 according to the present invention. Generally, the EC system 200 includes a plurality of EC nodes interconnected by one or more communication networks, such as communications network 202 and wireless network 240. Each EC node of the system 200 includes a number of components to facilitate monitoring and management of EC nodes. For example, as shown by the detailed EC node 250, each EC node includes computing or other resources 252 (again, these may be on one or more physical component that is networked including processing, I/O devices, memory, and the like), an MEC component 254, a persistence mechanism 270, and optionally, cache/memory 280. Generally, the MEC component 254 provided on each EC node has a service-oriented architecture (SOA) such that the EC system 200 provides an SOA approach for edge computing based on open standards, such as those implemented by JXTA and JMX. The MEC component 254, in one embodiment, uses JXTA to provide dynamic distributed mobile services in the EC system 200. Services in the MEC component 254 and, therefore, the EC nodes in system 200 that contain the components 254, are instrumented for monitoring and are configured for remote and self management, such as with JMX.

In the following discussion, computer and network devices, such as the software and hardware devices (or “EC nodes”) within the EC system 200, are described in relation to their function rather than as being limited to particular electronic devices and computer architectures and programming languages. To practice the invention, the computer and network devices may be any devices useful for providing the described functions, including well-known data processing and communication devices and systems, such as application, database, web, and entry level servers, midframe, midrange, and high-end servers, personal computers and computing devices including mobile computing and electronic devices with processing, memory, and input/output components and running code or programs in any useful programming language, and server devices configured to maintain and then transmit digital data over a wired or wireless communications network. Data, including transmissions to and from the elements of the network 200 and among other components of the network 200, typically is communicated in digital format following standard communication and transfer protocols, such as TCP/IP, HTTP, HTTPS, FTP, and the like, or IP or non-IP wireless communication protocols such as TCP/IP, TL/PDC-P, and the like.

In typical embodiments of the EC system 200, the EC nodes running the MEC component 254 will comprise low cost network appliances (e.g., blade servers, low end servers, and the like) and commodity client machines (e.g., desktops, laptops, notebooks, handhelds, personal digital assistants (PDAs), mobile telephones, and the like). This is shown in FIG. 2 with the EC system 200 comprising a number of EC nodes or devices connected via a communications network 202, e.g., the Internet, a local or wide area network, and the like, and a wireless, cellular, or similar network 240. A plurality of EC nodes are in the EC system 200 (and a typical system may have more or fewer EC nodes and may include one or more non-EC nodes, e.g., devices without an MEC component 254). The exemplary nodes include client EC nodes 210 (e.g., any computing device with resources or services useful to EC system 200), blade server EC node 216, laptop EC node 224, desktop EC node 220, client EC node 230 connected via non-EC node, server 228 and single-rack server EC node 232 with additional EC nodes 236, PDA EC node 242, and mobile phone EC node 248. Again, the specific configuration of the EC system 200 and its EC nodes is not limiting to the invention as the EC system 200 may vary significantly from location to location, from service to service, and from one point in time to another as EC nodes may be added or deleted dynamically.

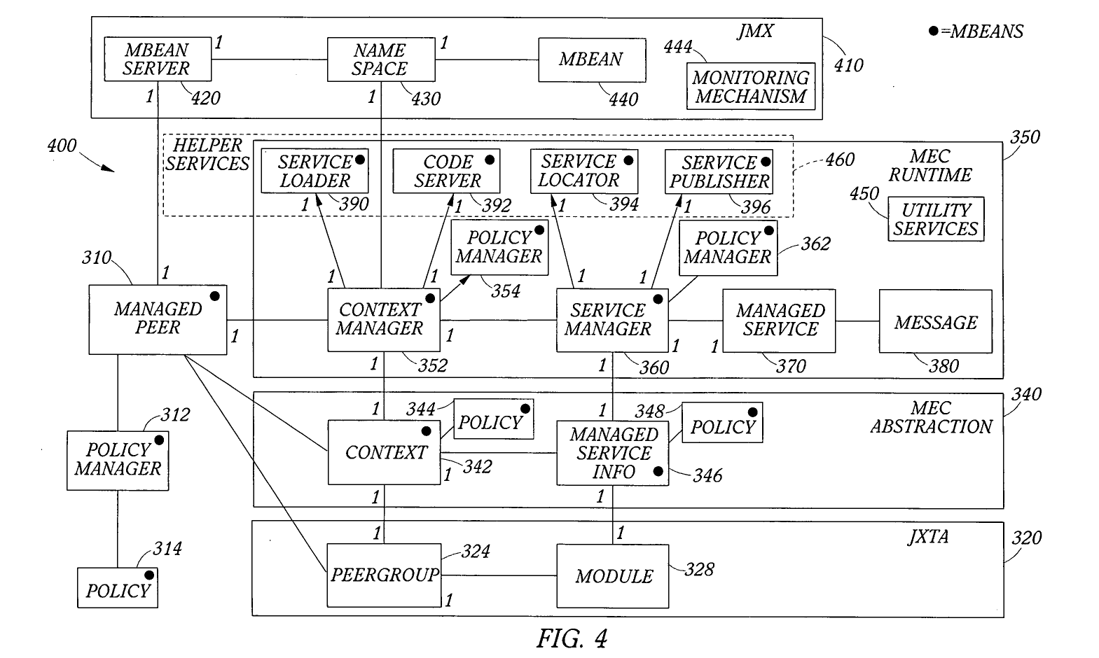

As discussed earlier, each of the active EC nodes in the EC system 200 typically will be configured similarly to the EC node (detail) 250 with computing resources 252 that are being shared in P2P fashion. At its most fundamental level, each EC node 250 includes an MEC component 254 to allow it to act as a peer such as a JXTA peer. Although each MEC component 254 typically includes other elements, the managed peer 256 is a core component to provide desired functionality of the EC node 250. Additionally, as will be discussed with reference to FIGS. 3 and 4, the MEC component 254 also includes at least monitoring and management tools 258 and utility and helper services 259. A persistence mechanism 270 and cache/memory 280 are provided for storing MEC or persistence data 284 to allow portions of the MEC component to persist locally on the EC node 250.

The MEC component 254, such as via the managed peer 256, is responsible in the EC system 200 for bootstrapping the EC node 250 and its MEC component 254 into the EC system 200 (or JXTA or other EC network within the system 200). The MEC component or peer 254 also functions to discover, offer, and utilize network resources (such as computing resources 252 on other EC nodes or on the same node 250). Further, the MEC component 254 acts to manage associations with other MEC components 254 or peers 256 and to manage communications. Peer associations within the EC system 200 are represented by peer groups while peer group behaviors and capabilities are provided by services offered/provided by the MEC component 254. Typically, both peers 256 and services 259 (or other services not shown) communicate with other network resources or peers, such as using pipes. Peers on the EC nodes in the EC system 200 are preferably autonomous and operate independently and asynchronously from each other.

FIG. 3 illustrates one embodiment of an MEC component 300, such as may be used for the MEC component 254 for EC nodes in EC system 200 of FIG. 2. As shown, the MEC component 300 is utilizing JXTA and includes the core JXTA-based elements of a managed peer or mPeer 310, context 342, managed services information 346, a context manager 352, a service manager 360, a managed service 370, and messages 380. Each of these, and other components, of the MEC component 300 are described in detail in the following discussion.

The MEC component or MEC framework 300 is built from a JXTA level 320, an MEC abstraction level 340, and an MEC runtime level 350 with managed peer 310 managed and/or run by a policy manager 312 based on a policy 314. The basic component for each node in a P2P system, such as EC system 200, is a peer and in the MEC component 300, the managed peer 310 is a core component. The managed peer 310 defines or joins one or more contexts 342 in which they participate. A context 342 contains information that maps it to one peer group 324. The managed peer is able to load zero or more contexts 342 at startup and is able to dynamically add and remove contexts 342 during runtime execution. When a managed peer 310 loads, creates, or adds a context 342, a context manager 352 instance is created. During managed shutdowns, the managed peer persists along with the non-transient context instances 342 (such as with persistence mechanism 270 and cache/memory 280 of FIG. 2).

Many managed peers 310 in an EC system may be “standard peers” in JXTA terminology, which means they do not provide infrastructure services by default. However, the managed peer 310 may autonomically via policy 314 and policy manager 312 (or by human interaction) become a “super peer” to offer infrastructure services, e.g., RendezVous, Relay, and Proxy JXTA services. The managed peer 310 caches resource advertisements in a local advertisement cache (not shown in FIG. 3 but shown as MEC data 284 in cache 280 in FIG. 2). By maintaining a local cache of services, overall managed peer 310 and EC system 200 performance is improved. The managed peer 310 uses its local cache to find available resources. Neighboring managed peers also cache the advertisements they discover, thereby reducing the discovery interval within the EC system. Managed peer 310 is responsible for maintaining their resource advertisements such as by managing their advertisements and ensuring the advertisements are republished before they expire. Managed peer 310 also provides resource expiration and taking steps to inform its context 342 when it stops providing a resource to the EC system 200.

A context 342 for which a context manager 352 has been instantiated can be thought of as a managed context. The context manager 352 manages a context 342 on behalf of the managed peer 310. The main responsibilities of the context manager include presence, communications, and service management. The context manager 352 acts as the managed peer's presence within the context 352 managing the managed peer's actions within the managed context 342. Instances of context managers 352 are concurrent and run in parallel. Each context manager 352 instance is separate and distinct from other instances in the managed peer 310. The context manager 352 performs discovery and joins the context's peer group 324 by publishing the managed peer's advertisement in the peer group 324. The context manager 352 is also responsible for discovery of other managed peers and services within the managed context 342.

A managed peer 310 is able to communicate with other managed peers in the same context 342. The context manager 352 is responsible for handling the communications. In one embodiment, the basic communication is provided by the JXTA Peer Information Protocol (PIP) which allows peers to share and query basic status information. In addition, each managed peer 310 participates in a context-specific propagate pipe communication. Using propagate pipe communication, the managed peer 310 is able to send and receive directive messages 380, allowing the managed peers 310 to cooperate, collaborate, and coordinate their actions. Changes in policy 314, 344, 348 are also propagated to managed peer 310 in this manner. Context manager 352 is responsible for the life cycle and management of services 370 offered by their managed peer 310 within the context 342. This task includes starting statically assigned services and dynamically assigned services as well as publishing the service advertisements within the context's peer group 324.

A context 342 may have zero or more associated services. Each service is represented within the MEC component 300 by an instance of managed service information 346 that contain all of the necessary information to declaratively define and describe a service. Managed service information instances 346 can be created dynamically to allow the introduction of new services to the MEC component 300 (and EC system 200) within a context 342. When a context manager 352 is created for a context 342, a service manager 360 instance is created for each managed service information instance 346 in the context 342. Policies 344 and 348 are associated with the context 342 and with the managed service information 346 with policy managers 354, 362 being provided for the context manager 352 and service manager 360 to provide policy enforcement in the MEC component 300.

The context 342 and managed service information 346 and their classes represent the basic MEC abstraction 340 of the MEC component 300. Context and managed service information instances 342, 346 are preferably persisted local to their managed peer 310. The default implementation stores instances of these classes as XML documents (or MEC data 284) on the local file system, e.g., cache 280 of EC node 250. Alternatively, Java Serialization, an XML datastore, or an object or relational database may be used to practice the invention. The persistence mechanism (such as mechanism 270 of FIG. 2) is selected and set during initial software installation, e.g., the software installation on each node or managed peer 310, which allows the use of different persistence mechanisms by different managed peer 310 instances. The persistence mechanism 270 preferably resides on the same compute node 250 as the managed peer 256 (or 310) that uses it. This helps ensure that each managed peer 256, 310 is able to act autonomously and independently as a separate and distinct individual node. An MEC component 300 is therefore a self-contained entity on a single compute node capable of interacting with other MEC components or instances 300, which are also self-contained entities, on the same compute node (e.g., a compute node or device may have more than one MEC component 300) or on remote, networked compute nodes. A persistence policy may be included on the MEC component 300 (or included in policies 314, 344, and/or 348) to define persistence behavior of the component 300.

Services within a context 342 may be further subdivided by the use of roles. A role is associated with one or more managed service information instances 346. A managed peer 310 may be statically or dynamically assigned a role within a context 342. When the managed peer 310 joins a context 342 with a role, its context manager 352 for the context 342 will only instantiate service manager instances 360 for managed service information instances 346 that are associated with the specified role. Roles may be defined for an entire EC system 200 incorporating MEC components 300, for each context 342, or a combination of both. Contexts 342 may optionally require the use of roles, and then if a managed peer 310 joins a context 342 that requires roles and does not specify a role, the MEC component dynamically assigns at least one role to the managed peer 310. Roles may be used to stereotype managed peers 310 and managed services 370. For example, a managed peer 310 running local to a database server may be given a role of “DATA” while another peer 310 running on or near a high performance platform may be give a role of “CALC.” Then, services 370 that are data intensive would be provisioned to or dynamically migrate over time toward the managed peer 310 with a role of “DATA.”

In the MEC component 300, domain specific application services are written to conform to or implement the managed service interface 370. The managed service interface 370 allows a service 346 to send and receive messages 380. The messages 380 in one embodiment are XML documents. The managed service instance 370 is managed by the service manager 360 in a one-to-one relationship. From the perspective of the managed service 370, the service manager's sole responsibility is to handle outgoing messages. This function is called service messenger and may be represented by an interface (not shown) of the same name. Basic messaging is typically asynchronous unicast, and whether the messaging is unreliable, reliable, or reliable secure, it is defined by a messaging policy enforced by the policy manager 362 at deployment and during runtime.

The information exchanged between collaborating managed services 370 are contained in messages 380, such as well-formed XML documents. The managed service 370 is responsible for the construction of the messages 380 it sends, such as by calling a send method of a service messenger interface so as to hide the public API of the service manager 360 to prevent direct access and manipulation of the managed service 370 and to simplify the managed service 370. In addition to the payload of the message 380, the sending managed service 370 specifies the service name of the target message recipient. The service manager 360 applies the current message policy 344 with the policy manager 362 in effect for the context 342 to determine the appropriate message delivery model. The service manager 360 is also responsible for locating the collaborating service that is the target of the message send, i.e., the receiver. The default behavior unless altered by the message policy 344 is to search for local instances of the target service. If a local collaborator is discovered, the service manager 360 of the message sender can call a local receive method of the message receiver's service manager for the managed service. If the message target is not local, the service manager 360 uses JXTA communications to send the message to a discovered target managed service 370. Typically, in both local and remote communications, the sending service manager 360 adds the name of the sending managed service 370. The service name of the sender is used by the message recipient to discriminate received messages, which allows the application implementation to provide separate message handlers or to prioritize messages based on senders. Other domain specific message handling techniques may also be provided by the application implementation.

As shown, the JXTA level or portion 320 of the MEC component 300 includes the peer group 324 and the module 328, which is discussed in more detail with reference to FIGS. 4-6. The MEC runtime level or portion 350 includes a number of helper services, such as the service loader 390, the code server 392, the service locator 392, and service publisher 396, that assist in the functioning of the context manager 352 and service manager 360 as discussed above and as will be discussed in more detail with reference to FIGS. 4-6. In FIGS. 4-6, many of the elements shown in the MEC component 300 are built upon with or without modification, and similar element numbering is utilized in these figures when similar components are utilized.

FIG. 4 illustrates a preferred embodiment of an MEC component 400 in which monitoring and management tools (such as tools 258 of the MEC component 254 of FIG. 2) have been added to the basic framework of the MEC component 300 of FIG. 3. In one embodiment, the monitoring and management tools are provided through use of JMX components and capabilities in a JMX level or portion 410, in utility service 450, and helper services 460 including instrumentation, an MBean server, dynamic loading, monitoring services, timer service, and relation service. The JMX MBean server 420 provides the registration and management of MBeans, which are shown in FIG. 4 to include many of the elements of the MEC component 400, including the managed peer 310, the policy manager 312, polices 314, 344, 348, context 342, managed service information 346, context manager 352, service manager 360, policy managers 354, 362, utility services 450, and helper services 460.

Each managed peer 310 instantiates an MBean server instance 420 and uses its peer name to create a top level name space 430. The MEC runtime components 350 including the managed peer 310, the context manager 352, the service manager 360 are instrumented and are registered with the MBean server 420 as MBeans 440. Instrumentation allows for monitoring and configuration of components during runtime, which forms the basis of the policy management and enforcement capability of the MEC component 400. Each context manager 352 registers as an MBean 440 using the name of its context 342 to create a namespace 430. Each service manager 360 registers as an MBean 440 using the name of its service 370 within its context 342. Every core element within the MEC component 400 is hence, instrumented and registered as an MBean 440 allowing each to be monitored and managed. If human interaction is useful, an administrative interface (not shown in FIG. 2) may be used to access the MEC components 254, 300, 400, 500, 600, such as by using a JMX HtmlAdaptor via a web browser. Alternatively, a Java-based MEC GUI console (not shown in FIG. 2 but optionally present on one or more of the EC components of EC system 200) can be used to manage local and remote components.

Using the management capabilities of the MEC component 400, elements, such as the context 342 and managed service information 346 instances, within the MEC abstraction 340 may be dynamically created and modified. Instances of these classes contain information required to instantiate the corresponding MEC runtime level 350 components.

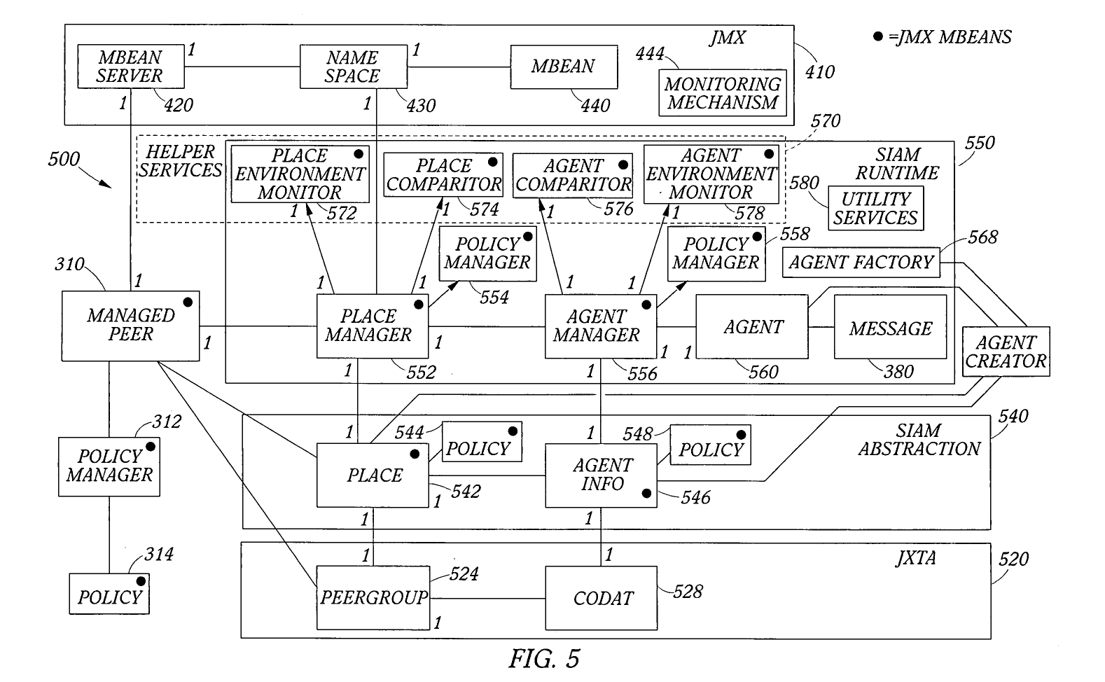

A powerful dynamic, mobile service distribution capability is provided by the MEC component 400 which leverages, integrates, and extends JMX capabilities, such as the JMX Mlet Service and capabilities of the JXTA module 328. In basic JMX, the Mlet Service uses a URL and Mlet file or class loader to dynamically instantiate services. In contrast, EC systems implementing MEC components 400 are able to use managed peers as both the instantiation target for a service as well as the service code source to dynamically deliver the service code, such as over the JXTA protocols. In one embodiment, this is achieved in part by using the MEC component's extension for a managed service implementation 370, e.g., a ModuleImplAdvertisement extension for a managed service implementation, and by using the code distribution helper services 460, e.g., the service loader 390, the code server 392, service locator 394, and service publisher 396. In other words, services can be delivered from any node implementing a managed peer 310 autonomically and with human interaction such as via an administrative interface or GUI, and this can be labeled the dynamic code mobility feature of the MEC component 400. As explained with reference to FIG. 5, the SIAM horizontal overlay extends this capability further to provide dynamic service (or agent) replication and migration due to proactive and/or reactive stimuli.

As shown in FIG. 2, each EC node includes an MEC component 254 that includes monitoring tools 258 that provide the ability to monitor various types of values known as “monitors” for each MEC component 254. In one embodiment, this is achieved using monitoring services provided by JMX, as shown with monitoring mechanism 444 in FIG. 4. The monitoring mechanism 444 uses monitors to register listeners and generates event notifications based on changes to a monitor. The MEC component 400 combines the JMX monitoring mechanism 444 with various JXTA monitoring and metering capabilities and further, extends both of these to provide the basis for the ability of the MEC component 400 to self monitor and self manage itself according to policy settings 314, 344, 348. Monitoring within the MEC component 400 provides the basis for context awareness, self awareness, and self organization.

More particularly, as the managed peer 310 and its components are instantiated, they are registered via the MBean server 420 as MBeans 440. As an MBean 440 is registered, various monitors specific to the component are instantiated by the monitoring mechanism 444 or other devices. Applicable policies 314, 344, 348 are evaluated to set the values of the monitors, which are also registered with the MBean server instance 420. Since the monitors themselves are MBeans, they too can be managed. The ability to manage monitors provides the basis for policy management and enforcement as well as autonomic behaviors within the MEC component 400.

The monitoring mechanism 444 may include a JMX timer service that sends notifications at specific time intervals which can be a single notification to all listeners when a specific time event occurs or a recurring notification that repeats at specific intervals for a period of time or indefinitely. The MEC component 400 uses the timer service to support time and interval-based actions such as synchronizing activities of its elements. For example, a timer can be used to control the statistical analysis rates of an MEC component 400 within a context 342. Elements of the MEC component 400 collect information regarding their activity and generate statistics for evaluation against policy 314, 344, 348. Time events can also be used to notify elements of the MEC component 400 to dynamically reconfigure themselves to support known changes in activity. For example, an element of the MEC component 400 may alter tasks based on time of day, day of week, and the like or timer events can cause the managed peer 310 to join or leave a context 342, to change roles, to add/remove services 370, and the like.

The MEC component 400 may also include a relation service (not shown) in the JMX level 410 or elsewhere to provide the facility to associate MBeans 440. The relation service can be used to provide metadata to describe elements of the MEC component 400 to enable policy-based relationships between registered MBeans 440. The relation service is used to ensure consistency of the relationships and policy enforcement. In the MEC component 400, the relation service is used to provide and enforce role and relation information. The managed services 370 may be assigned roles that are typically domain specific and correspond to one or more managed service 370. The managed service information 346 may optionally contain the relation service metadata. The MEC component 400 uses the optional role information of the managed peer 310 to dynamically determine which services are instantiated on a managed peer instance and to manage and enforce the policy-based relationships.

The MEC component 400 includes a number of utility services 450 and helper services 460. Generally, the utility services 450 includes services that provide one or more functions that are provided on a near continuous basis whereas helper services 460 assist one or more of the main MEC elements to perform a specific task. The monitors used by the monitoring mechanism 444 may be provided as utility services 450. Other utilities 450 perform the statistical analysis and handle discovery responses and other event listening tasks. Another utility service 450 is the policy management and enforcement mechanism described in detail below.

The helper service 460 perform MEC component 400 tasks on behalf of its elements and as shown, includes a service loader 390, a code server 392, a service locator 394, and a service publisher 396. The service loader 390 is used by the context manager 352 to implement dynamic code mobility that enables the dynamic provisioning of managed services 370 from remote managed peers to the local managed peer 310. In this regard, the service loader 390 is responsible for dynamically loading the requested managed service 370. Services 370 loaded dynamically may be transient, which means they are not persisted locally and will not be restarted if the managed peer 310 is restarted or may be non-transient, e.g., be persisted locally. Operation of the service loader 390 is set by policy 314, 344, and/or 348, with the default being transient loading. The code server 392 is a helper service 460 used by the context manager 352 to implement dynamic code mobility. Specifically, the code server 392 is responsible for servicing code provisioning requests from managed peers other than the managed peer 310 by delivering code to the requesting managed peer. The service locator 394 is used by the service manager 360 to locate other managed services outside the MEC component 400. The other managed services are known as collaborators to the MEC component 400 and are the recipients of messages 380, or the message target, of the managed service 370. The service publisher is used by the service manager 360 to publish the advertisements of the managed service 370.

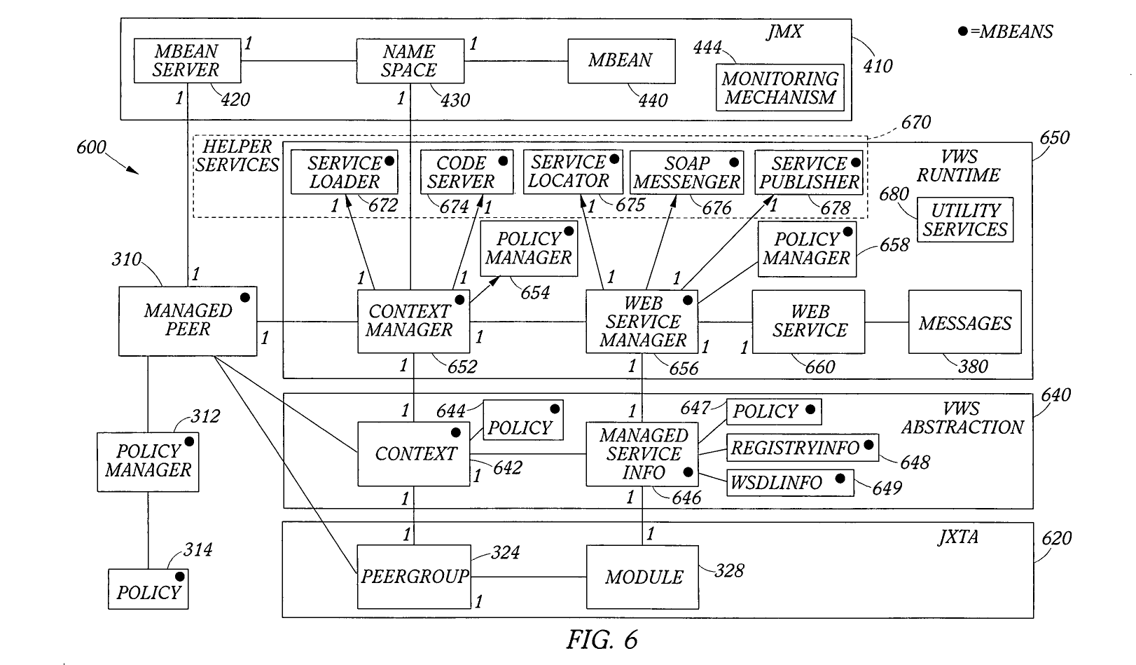

Policy management is the ability of the MEC component 400 to manage policies 314, 344, 348. The MEC policies 314, 344, 348 are used to declaratively define the acceptable operational parameters and activities of the components to which they apply. Policy information, provided by instances of policy and its subclasses 314, 344, 348, are is used to define the policies in effect at any point in time. A useful feature of the MEC component 400 policy management and enforcement 450 is not the contents of the policy instances 314, 344, 348 but, instead, the simple policy mechanism 450 and its enforced application throughout the MEC component 400 (and other MEC components within an EC system 200) and overlays as discussed with reference to FIGS. 5 and 6.

Policies may be applied at one or more discreet levels, i.e., pre-action, post-action, and monitored, with any MEC component 400 action subject to one or more policy considerations. A pre-action policy is applied before the action is taken. The action is evaluated in the context of the current set of applicable policies by the enforcement mechanism 450 and the action is taken if allowed by policy. If the action would violate a policy 314, 344, 348, a policy log entry is generated and any associated notifications are fired. A post-action policy is applied after the action is taken, with violated policies resulting in policy log entries being generated along with notifications. Monitored policies are conditions that are monitored for change or deviation outside of acceptable bounds. Monitoring mechanism 444, utility services 450, and other monitoring tools in the MEC component 400 are used to provide basic policy enforcement. When policy changes are made autonomically or by human intervention, monitor values are changed within the MEC component 400 as necessary with notifications being sent to all affected registered listeners. Additional reactions to policy violations are also typically supported, including stopping the component 400 that violates a policy, limiting access from/to the component 400 until corrective action is applied, and the like.

The framework provided in the MEC components 300 and 400 can be extended or built upon to provide new solutions for specific edge computing and other distributed computing environments. These solutions can be labeled “overlays” that provide a set of components that leverage, derive, and/or extend the core capabilities of the inventive MEC components or frameworks described with reference to FIGS. 3 and 4. Horizontal overlays are overlays that are general purpose in nature and are intended to be used across application and business domains. The following sections describe with reference to FIGS. 5 and 6 two horizontal overlays, i.e., a Simple Intelligent Agent Management (SIAM) horizontal overlay and a Virtual Web Services (VWS) horizontal overlay. While each of these overlays is separate and distinct, they are designed to interoperate. For example, SLAM agents can be exposed as virtual web services and conversely, virtual web services can use SIAM context, self awareness, and other elements. With an understanding of these two overlays, it is expected that those skilled in the art will readily produce additional overlays that build on the features of the MEC components 300 and 400 and are considered within the breadth of this disclosure.

A SLAM overlay or SIAM MEC component 500 is illustrated in FIG. 5. The purposes and goals of the SIAM overlay 500 are to provide an ad hoc, distributed platform upon which mobile, intelligent agents can interact and perform tasks. The SIAM overlay 500 is light weight and simple when compared to other mobile agent frameworks and platforms. The SIAM overlay 500 achieves simplicity by leveraging peer-to-peer communications and distributed management technologies provided by the MEC framework discussed with reference to FIGS. 3 and 4. The basic premise of the SIAM overlay 500 is to provide a simple, secure environment in which many types of mobile agents can be developed, deployed, distributed, monitored, and managed. The SIAM overlay 500 defines a simple framework having a set of core components that can be used to build more complex mobile multi-agent systems. The SIAM overlay allows application developers to focus on the development of their intelligent mobile agent applications and not the underlying infrastructure.

There are eight major components that provide the core functionality of the SIAM overlay 500, i.e., a place 542, a place manager 552, an ecosystem, a universe, agent information 546, an agent 560, an agent manager 556, agent utilities 580, an agent factory 568, and an agent creator 564. Many of these components are shown in the SIAM overlay 500 along with their relationships. The SIAM overlay 500 includes a managed peer 310 with policy manager 312 and policy 314 and has a framework of a JXTA layer 520, a SIAM abstraction 540, a SLAM runtime 550, and a JMX layer 410.

Places 542 are the fundamental habitat in which mobile agents 560 “live and work” or perform their assigned tasks. A place 542 is an extension of an MEC context 342. A place 542 defines a set of environmental properties that are often initialized at create/deploy time and vary over the lifespan of the place instance 542. Agents 560 use the properties of the place 542 to form a conceptual model of their runtime or operational context 550. In addition, agent activities may affect the environmental or operational context of a place 542. Place instances 542 may be persisted in the same manner as their parent class context 342.

Managed peers 310 may host one or more place instances 542. The managed peer 310 defines or joins one or more places 542 in which they participate. During runtime, required or static places 542 are loaded from persistence and may be persisted as required throughout the life of the managed peer 310. Additionally, the place 542 may be dynamically added or removed from a managed peer 310 as required either autonomically or through human direction. During managed shutdown, a managed peer persists all non-transient place instances 542. Similar to a context 342, a place 542 encapsulates a single JXTA peer group 524.

For each place instance 542 created, joined, or provisioned to a managed peer 310, a place manager instance 552 is created to manage the place 542 on behalf of its managed peer 310. When the managed peer 310 loads a place 542 from persistence or is dynamically provisioned a place 542, it creates an instance of place manager 552. The place manager 552 is responsible for advertising the existence of a place instance 542 within the SIAM overlay 500. The place 542 may attract or repel mobile agents by communicating or advertising their resources, with the resources of a place 542 defining the basic environment of the agent 560.

Each place manager 552 is responsible for keeping a local registry of the mobile agents 560 they are hosting. This information may be accessed by other components in the SIAM overlay 500 or other SIAM components if they are allowed to do so by the security policy 544 of the place 542. At a minimum, local agents 560 or agents running in the same managed peer instance's place manager 552 are able to query the local agent registry directly. This is a difference between the MEC components 300, 400 and the SIAM overlay or SIAM component. In the MEC components 300, 400, the framework components manage the environment on behalf of managed services 370 whereas in the SIAM overlay 500, the agents 560 are able to interact directly with the environment. Agents 560 can evaluate or sense the environment and effect the environment through the activity. Agents 560 can monitor and analyze their current place 542 to plan their possible actions. Agents 560 can determine what agents are local, what additional places are available, and obtain information of these other places. Agents 560 may use this information to determine their migration and replication strategy, for example. In this manner, agents 560 are more self-directed whereas managed services 370 are managed by the policy enforcement 354, 362 of their context manager 352 and service manager 360. The place manager 552 performs statistical analysis of its state as the agent 560 performs its activity. The analysis policy determines the statistical analysis interval.

Another extension of the MEC component 300, 400 in the SIAM overlay 500 is the manner in which the MBean server 420 is used. SIAM agents 560 have direct access to most of the components registered in the same namespace 430. In the SIAM component 500, the MBean server namespace 430 corresponds to the name of the place 542. Agents 560 may expose and register additional interfaces directly to the JMX level 410 as MBeans 440. For example, a typical action would be for an agent 560 to search the MBean server 420 for potential collaborators. Migrating mobile agents 560 only exist within a place 542 if they are registered. As mobile agents 560 migrate, they register with their target place 542 and deregister with their current place. Replicating agents do not deregister with their current place though their replicants would register with their target place.

Place managers 552 may implement barriers to agent 560 migration by allowing only certain mobile agents 560 that meet entry requirements. This behavior is a type of filtering and is an extension of the MEC component 300, 400 role capability. Simple agent screening can be implemented by advertising environmental information that acts to repel certain “undesirable” agents and to attract other types of agents. Advanced alternatives may include mobile agents 560 within a place manager instance 552 collaborating to prevent other mobile agents from emigrating to their place, thereby essentially protecting their turf. Place managers 552 provide their environmental information to agents 560. Agents 560 may request the information actively or register for notifications of environmental changes. Agents may also request information regarding other place manager instances on other managed peers. Unlike MEC component 300, 400 managed services 370, the SIAM agent may ask their place manager 552 for a list of known discovered place instances 542. The agent 560 may then evaluate the available places 542 through direct messaging 380 to the remote place over the place communication channels.

The collection of place manager instances 552 for the same peer group 524 constitute a SIAM ecosystem. Mobile agents 560 are free to roam among the places 542 of an ecosystem. It is also possible for agents 560 to “transcend” their ecosystems by moving from one ecosystem to another if allowed by the security policy of the two place instances. Barriers to movement between ecosystems may be employed. Ecosystems provide the context for inter-place communication facilities. Places 542 are able to share information and notify each other of significant changes. Ecosystem communication augments the direct agent-to-other place communication behavior to allow agents 560 to communicate with their current host place 542 and delegate the message propagation responsibility. In other words, the requesting agent's host place 542 may be asked to forward the message to other places within its ecosystem and deliver any responses to the requesting agent via a callback.

A universe is the space of all ecosystems and may be defined to be inclusive, i.e., only those ecosystems that allow agents to transcend between them, or to be exclusive, i.e., all ecosystems regardless of agent transcendence. A universe is defined and enforced by a policy that associates two or more ecosystems and defines the allowed transcendence between each ecosystem pair. Agents 560 can request universe information from their local place manager 552 and request to transcend to one or more allowed ecosystems. The allowed transcendence may further specify the types of agents 560 allowed to perform which transcend actions. A transcend action is similar to migrate or replicate actions that occur within an ecosystem. A transcend may be a migration where the agent instance 560 moves from one ecosystem to another or a replication where a copy of the agent 560 is deployed to the target ecosystem. The managed peer instance 310 that hosts a place manager 552 of the target ecosystem may be the same as the current managed peer or another managed peer within the SIAM-based EC or other computing system. The agent 560 will not have visibility to the available places in a target ecosystem prior to transcendence. Instead, the SLAM overlay 500 dynamically determines the target managed peer during runtime.

In the SIAM overlay 500, agent information instances 546 perform much of the same functionality based on policy 548 as the managed service information instances 348 of the MEC components 300, 400. A place 542, which functions based on policy 544, typically defines one or more agents 560. Each place instance 542 may have zero or more associated agents 560. Each agent instance 560 is represented within the SIAM framework 500 by an instance of agent information 546. Agent information instances 546 contain all of the necessary information to declaratively define and describe an agent 560. Agent information instances 546 can be created dynamically to allow the introduction of new agents 560 to the SIAM-based system or SIAM overlay 500 within an ecosystem. Agent information instances 546 can be sent to place instances 542 or place manager instances 552 running on different managed peers. When a place 542 is loaded by a managed peer 310, the associated agent information instances 546 are loaded and the place 542 instantiates an agent manager 556 for each instance 546, which in turn creates the agent 560. Agent instances 560 may use their agent information instance 546 to store information that can be used the next time the place 542 is reloaded and restarted.

A SIAM agent 560 is an extension of the MEC components 300, 500 managed service 370. The agent interface 560 provides additional interactions with the place manager 552. Agent interfaces 560 interact with a place manager 552 via an agent manager instance 556 in the runtime environment 550. Agents 560 are the primary component in the SIAM overlay 500, and the reason for the existence of all of the other elements and features which provide support to the agents 560. Agents 560 implement and execute domain logic, performing their appointed tasks according to their internal motivations (goal direction) in the most effective manner given their knowledge of their environment defined by places 542, ecosystems, and universes. Agents 560 only exist in the SIAM overlay 500 once they are deployed to a place 542 and an instance of an agent manager 556 is created. Agent implementations 560 that provide at least one mobile behavior, such as migration or replication, are known as mobile agents and those that are tied to specific managed peers 310 are considered static agents.

Managed services 370 use the JXTA module 328 advertisements to advertise their availability to the MEC-based EC system as well as to support dynamic code mobility. When a new instance of a managed service 370 is created, the new instance is separate and distinct form all other instances. New instances of SIAM agents 560 may be created in the same manner allowing the creation of multiple separate and distinct agent implementation instances. However, a SIAM agent 560 that migrates or replicates maintains its current state or some portion thereof. In the MEC component 300, 400, managed services 370 are essentially stateless in that they do not maintain conversational state. When a message 380 is sent to a target managed service 370, the sender does not care which instance services the request only that the request is handled. Instances of the same managed service 370 are redundant. Stateful managed services 370 are possible but support for conversational state is the responsibility of the application developer.

This is not the case with SIAM agents 560. At the JXTA layer 520, agent instances are JXTA Codat instances 528. A Codat 528 contains both code and data, i.e., behavior and state. Since each Codat instance 528 may contain instance specific state, the Codat ID will be different for each instance. The name of each Codat 528 will be the same with the Codat metadata including an agent ID as a string. The agent ID is part of the JMX object name used to uniquely define an agent 560 as an MBean 440. The agent ID of a new instance created by using a new instance constructor will have an agent ID of “1”. If this agent 560 replicates, the new replicant agent instance will have an agent ID of “2” and so on. If the agent replicant with an agent ID of “2” replicates, its replicants will have agent IDs of“2.1” and so on. Each agent instance 560 is responsible for maintaining the agent ID value of its most recent replicant.

Agents 560 monitor their environmental state through communication with their agent manager 556 and also obtain information about their ecosystem and universe from the agent manager 556. The agent uses the information available from its agent manager 556 as input to its analysis, planning, decision making, and execution as defined by the agent developer. Agent activity also affects the place manager's operational state. The agent manager 556 monitors and handles the translation and reporting of its agent's activities to the place manager 552.

The SIAM overlay 500 includes a number of agent utilities 570 in its runtime 550 that act to collect, monitor, and analyze environmental information, which can be used by the agent 560 in its planning, evaluation, and decision making processes to determine possible and appropriate courses of action and execution. Initially, however, it should be noted that an optional capability provided by the place manager 552 is a synchronization mechanism that uses the JMX timer services to provide discreet time synchronization within a place manager instance 552. The place manager's configuration and policy determine if synchronization is provided, the interval, and duration. At each discreet interval, notifications are sent to each registered listener. The interval notification acts as a synchronization point for all of the registered agent managers 556, and thus, agents 560, to provide a level of coordination for local agent activities. Agents 560 may use the interval to analyze their own performance. For example, an agent that is still processing information from the last interval when it receives another interval notification may adjust its activities, reprioritize, ignore requests, log the error, notify its owner or system administrator, replicate itself, and the like.

One agent utility 570 is the place comparator 574 that allows an agent 560 to compare two or more place managers 552 on one or more specific environmental factors or an overall value for an instant or over a time interval. Using the interval mechanism, the place comparator 574 may cache a history of the environment that can be used for time-based performance statistical analysis. This information may be used by an agent 560 to determine not only where to migrate but when (for example). The agent comparator 576 is a utility that allows an agent 560 to compare itself to other instances of the same agent class and to compare instances of the agent with which it collaborates. The comparison is based on the statistical monitoring and analysis performed by each agent manager 556. The comparison is performed in a virtual moment in time, that is, the comparison is a snapshot of the compared agents subject to the latency in the communications. In most cases, the communications latency has a negligible impact. Comparisons are relatively expensive operations and are typically performed when an agent 560 determines it is not operating within an acceptable range. Comparison is part of the self-awareness and awareness of other agents features of the invention. There are also informational services that allow agents 560 to query the state of a place 542 or an agent. These are context or environmental services that form the basis of an agent's habitat awareness. These services are provided by the place manager 552 and the agent manager 556, respectively.

While the place manager 552 is ultimately responsible for its own monitoring, metering, and statistical analysis, it is the place environment monitor 572 that carries out the associated tasks. The place environment monitor collaborates with the place policy enforcement (e.g., via policy manager 554 or enforcement mechanism not shown) to ensure policy compliance and to make adjustments as required. In a similar manner, the agent manager 556 is responsible for the monitoring, metering, and statistical analysis of its agent 560, but uses the agent environment monitor 578 to carry out the associated tasks. The agent environment monitor 578 collaborates with the policy manager 558 and/or other agent policy enforcement mechanisms to ensure policy compliance and to make adjustments to the agent 560 as required. The place and agent monitors and policy enforcers also interact to inform each other as the effects of the various concurrent activities occur during the life span of the place manager 552 and agent 560 within the place 542.

The SLAM overlay 500 augments and extends the MEC helper services 460 to provide similar capabilities with the helper services 580. Additional behaviors are used to assist the agent 560 in migration and replication. The use of JXTA modules 328 is replaced with the use of JXTA Codats 528. Additionally, the public API of the helper services 580 is directly accessible to the agent 560. The SIAM overlay 500 includes the ability to specify one or more agent factory instances 568, which may be considered a helper service 580, that allow domain application agent developers to create and register factory classes for one or more types of agents 560. Agent factories 568 are a convenience since it is possible to dynamically define and instantiate and deploy agent information instances 546, as defining an agent information instance 546 from an uninitialized state can require significant effort and be prone to error. The agent factory instance 568 simplifies the creation and deployment of new agent instances 560, and may be configured as a JXTA peer service itself using the JXTA module 328 mechanism which means agent factory instances 568 can be dynamically discovered and used during runtime. In some cases, the agent factory 568 is implemented as an MEC managed service 370 providing instances with all of the associated management, monitoring, and mobility capabilities (and typically, would be a registered MBean). The agent factory 568 preferably collaborates with the current set of applicable runtime policies 314, 544, 548, and the like and a set of configuration parameters to determine and set the initial default state of the agent information instance 546.

A primary user of the agent factory 568 is the agent creator 564. Agent creator instances 564 are loaded by a managed peer 310 in much the same manner as a SIAM place 542. The agent creator 564 encapsulates one JXTA peer group 524. A managed peer 310 may have one or more agent creator instances 564. The agent creator 564 uses the MEC role capability to statically and/or dynamically provision and determine the set of available agent factories 568 and agent information instances 546. The agent creator 564 interacts with the agent factory 568 to create and deploy agent instances 560. The agent creator 564 represents a managed peer's ownership of deployed agents 560. The agent creator 564 has a unique JXTA peer ID that is used to set the creator parameter on each agent information instance 546 created, and agents 560 may use this information to validate requests for information or goal and behavior modifications. In some embodiments, agents 560 that enforce the agent creator access model are known as owned agents. Owned agents will only respond to communications signed or containing the agent creator ID. The ID may be encrypted or communicated via a secure channel to prevent unauthorized access to an agent's information.

Once its agents 560 are deployed, the agent creator 564 may selectively: receive messages from the mobile agent, monitor their mobile agents (actively or passively); update mobile agent execution parameters (for example, change instructions, goals, and the like); request a place, ecosystem, or universe change; control the agent lifecycle (e.g., request a migration, request a replication, or destroy the agent); and request the agent to store messages while the agent creator is not active or goes offline. Other behaviors specific to particular agent types and agent creators 564 may be defined and exposed via the JMX instrumentation level 410. The agent creator 564 can discover and communicate directly with their agents 560. Alternatively, agent developers may leverage callback mechanisms that allow an agent 560 to send messages of interest to their agent creator 564. The default set of available agent notifications to their agent creator 564 includes migration, replication, transcendence actions, and log messages at a specified log level. Domain application developers may use the callback mechanism to notify an agent creator 564 of significant domain events.

Policies 314, 544, 548 determine the message model for the callback as well as the caching and handling of message delivery failures. For example, a policy may call for the use of unreliable unicast communications, and the agent 560 sends its messages 380 to its agent creator 564 without regard to successful delivery. Any messaging model policy can specify a cache size and/or message age. If a reliable messaging model is used, the policy may specify the cache size (e.g., number of messages) and age of messages not successfully delivered to the agent creator or may specify a number of retries before the delivery failure is logged. The policy may also specify message summarization and interval delivery. This is useful for long lived agents 560. For example, an agent 560 may cache significant event messages and deliver the cache contents once every hour. SIAM overlay 500 will create a JMX timer service for the specified interval and register a listener for the agent 560. The timer will notify the agent 560 to send its event cache to its creator 564.

FIG. 6 illustrates a virtual web services (VWS) horizontal overlay 600 according to the invention. The VWS horizontal overlay or component 600 builds on the MEC component or framework 400 of FIG. 4 with modifications and extensions in a VWS abstraction 640 and VWS runtime 650. The VWS component 600 is designed to allow MEC managed services 370 and/or SIAM agents 560 to be exposed as standard web services and/or interact with standard web services offered on other heterogeneous environments (such as web services that use and conform to WSDL, UDDI, and SOAP (WUS) standards and ebXML Registry and Repository standards). A purpose of the MEC framework 300, 400 is to enable managed dynamic distributed edge computing. Web services implementations are a form of SOA, and hence, it is desirable to expose the managed services 370 as web services and allow them to interact with other web services. The VWS overlay 600 provides definitions in WSDL to provide the services 370 and agents 560 as web services, facilitates registration in web services registries (such as a UDDI registry and/or an ebXML registry) to allow them to be discovered and used as web services, and enables them to send and receive web service messages (e.g., messages following the SOAP protocols).

As shown in FIG. 6, the major components of the VWS overlay 600 are the web service information instance 646, the WSDL information instance 649, the registry information instance 648, the web service 660, the web service manager 656, and the SOAP messenger 676. Policies are provided in policy 314, 644, 647 that are enforced at least in part by policy managers 654, 658 and other policy enforcement mechanisms such as those provided in utility services 680 and/or in helper services 670. The context 642 and context manager 652 are similar to the context 342 and context manager 352 of FIGS. 3 and 4.

The web service information instance 646 contains all of the necessary information to declaratively define and describe a web service 660. Web service instances 660 can be created dynamically to allow the introduction of new services to the VWS-based system or VWS overlay 600 within a context 642. A web service information instance 646 contains a number of other information objects used to describe and provide other key aspects for the specification of a web service 660 used for the deployment. A managed service information instance 346 and a SIAM agent information instance 546 may contain a web service information instance 646. If a web service information instance 646 is discovered, the MEC component 400 and SIAM overlay 500 will create the necessary infrastructure to support web service deployment. Policies and descriptors determine whether a service 370 or agent 560 is exposed as a web service 660, is able to use other web services, or both. The presence of a web service information instance 646 will instantiate utilities to support web service, e.g., helper services 670 and utility services 680.

WSDL information instances 649 are persistent objects that contain information regarding the WSDL definition of a VWS web service 660. The tools available in the Java Technologies for Web Services may be used to generate WSDL documents in some embodiments. A WSDL information instance 649 may contain the entire contents of a WSDL document or it may refer to a URL that contains the information. Alternatively, a WSDL document may be published using a JXTA content advertisement, which can be stored in the WSDL information instance 649. When a web service instance 660 is created, its WSDL information instance 649 is used to find and load the corresponding WSDL document.

Registry information 648 are persistent objects that contain information describing the required web services registries in which the web service instance 660 is to be registered. Registries that are to be used to find collaborators are also specified in the registry information 648. When a web service instance 660 is created, its registry information instance 648 is used to register and obtain references to registries, such as to use leveraging JAXR.

The VWS web service 660 is the domain application implementation of a web service. The web service 660 implements the domain behavior of the web service and exposes the API via JAX-RPC (for example). The web service implementation class may contain the generated Java classes created by binding using, for example, a JAXB binding compiler. The web service implementation 660 provides a WSDL document that is contained in an instance of WSDL information 649. In one embodiment, the web service 660 is run through the JAX-RPC mapping tool to generate the appropriate ties, stubs, and classes and packaged in a WAR file. The information is then used to populate a web service information instance 646. Alternatively or in addition to supporting JAX-RPC, JAXM and SAAJ messaging may be supported by the VWS web service 660. The send mechanism of the MEC framework 400 is then over-ridden by VWS overlay 600 to delegate message sends to the SOAP messenger 676.

The web service manager 656 is the container for the runtime web service instance 660. It is responsible for registrations, messaging, collaboration, bindings, and RPC exposure of the web service 660 it manages. The web service manager 656 uses the available information objects previously described as well as policy and context information to interoperate with most of the Java Technologies for Web Services (e.g., JAXB, JAXP, JAX-RPC, JAXM, JAXR, SAAJ, and the like) to expose the managed web service 660. The web service manager 656 delegates communication responsibilities to the SOAP messenger 676.

The SOAP messenger 676 is a helper service 670 that uses the WSDL information instance 649, the registry information 648, and a number of Java Technologies for Web Services (e.g., JAXB, JAXP, JAX-RPC, JAXM, JAXR, SAAJ, and the like) to find, send, and receive messages or RPC APIs. The SOAP messenger 676 uses the descriptive information and processing capabilities of the web service manager 656. In turn, the web services manager 656 offloads communications responsibilities to the SOAP messenger 676. The SOAP messenger 676 is responsible for determining the appropriate interaction model based on policies 312, 644, 647 and request mechanism. The SOAP messenger 676 is further responsible for getting a connection, creating a message 380, populating the message 380 with the contents from the manage web service 660, and sending the message 380, such as with SAAJ. This mechanism is used for two-way synchronous request-response interaction. If the target receiver is another VWS web service and local (i.e., registered in the JMX MBean server 420), direct blocking messaging may be used; if remote, JXTA bi-directional messaging protocols may be used. The SOAP messenger 676 may also use JAXM to leverage a messaging provider when indicated and to send one-way asynchronous messages 380. If the target receiver is another VWS web service and local, direct non-blocking messaging may be used and if remote, JXTA messaging protocols may be used. The SOAP messenger 676 may also use JAX-RPC to translate a web service 660 method call to the remote service, i.e., to dynamically obtain the service endpoint from the JAX-RPC runtime. If the target receiver is another VWS web service and local, a direct method call may be used but if remote, it may be useful to use JXTA bi-directional messaging protocols.

In addition to the utility services 680 that support JAX-RPC runtime environment and a JAXM messaging provider, the VWS overlay 600 has a number of other helper services 670. Generally, the MEC helper services 460 and utility services 450 are extended to support web services-specific capabilities. For example, the MEC code server 392 is extended by the web service code server 674 to serve web application archives (WAR) files. The MEC service loader 390 is extended by the web service loader 672 to support dynamic code mobility for web services 660. While the service publisher 396 handles the publishing of a managed service 370, the web service publisher 678 handles the registration of the web service 660 in the required registries set by registry policy 647 and registry information instance 648, typically using JAXR. While the service locator 394 and agent locator are used by the MEC component 400 and SIAM component 500, respectively, to find available managed services and agents, the VWS provides a web service locator 675 that collaborates with these services to find local and remote MEC and/or SIAM service implementations as well as using JAXR or other technologies to search registries defined in the registry policy 647 and the registry information 648. From the SIAM overlay 500, the helper services 670 are extended to support web services 660. For example, the replication and migration actions and exposure of SIAM agents 560 and their JXTA coats 528 are reflected in updates to the various web services registries in which they participate.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A method for monitoring and managing distributed services in a network, comprising:
at an edge computing node of the network, instantiating a managed peer, a context, and a managed service;
establishing a monitor for the managed peer, the context, and the managed service;
monitoring a value of the monitor for the managed peer, the context, and the managed service; and
modifying the managed peer, the context, or the managed service based on the value of the corresponding one of the monitors.

2. The method of claim 1, further comprising registering the managed peer, the context, and the managed service with a monitoring server associated with the monitor.

3. The method of claim 2, further comprising prior to the modifying, comparing the monitored values to acceptable bounds defined in a set of policies registered with the monitoring server and only performing the modifying when one of the values is outside the acceptable bounds.

4. The method of claim 1, wherein the monitoring and the modifying are performed during runtime and the modifying comprises altering the configuration of the managed peer, the context, or the managed service.

5. The method of claim 1, wherein the monitoring of the value comprises collecting and analyzing state information for the managed peer, the context, and the managed service.

6. The method of claim 5, wherein the modifying comprises tuning operational parameters.

7. The method of claim 6, further comprising operating the managed peer to cache advertisements of services of other managed peers in a local cache and to search the local cache for available resources.

8. The method of claim 1, further comprising instantiating a service locator and a service loader, operating the service locator to locate a managed service offered by a peer remote to the managed peer, and loading the located managed service on the edge computing node with the service loader.

9. The method of claim 8, wherein the loading operating by the service loader is performed based on a set of policies.

10. The method of claim 1, further comprising instantiating a code server, receiving a provisioning request for the managed service from another managed peer, and delivering code corresponding to the managed service to the requesting managed peer.

11. The method of claim 1, further comprising the managed peer joining a peer group associated with the context and publishing an advertisement for the managed peer in the peer group, wherein the published advertisement is accessible by other managed peers belonging to the peer group.

12. An edge computing node for use in a network utilizing policy-driven service distribution, comprising:
computing resources;
a managed peer adapted for communicating with other managed peers belonging to a context;
a service provided by the managed peer based on the computing resources;
a management registry in which the managed peer and service are registered;
a monitoring mechanism gathering environmental information for the managed peer and the service during runtime and associated with the context;
a set of policies defining configuration and interaction parameters; and
a management mechanism comparing the gathered environmental information to the set of policies and controlling configuration or operation of the managed peer and the service based on the comparison and the set of policies.

13. The node of claim 12, wherein the set of policies are associated with the context.

14. The node of claim 12, wherein the monitoring mechanism comprises listeners gathering state information for the edge computing node during runtime.

15. The node of claim 12, further comprising a service locator for discovering additional computing resources in the network associated with the context and a service loader requesting a service based on the discovered additional computing resources based on the comparison by the management mechanism and loading the requested service on the edge computing node, the loaded services being configured or operated based on the set of policies.

16. The node of claim 12, further comprising a service publisher advertising the service to other nodes in the network associated with the context and a code server distributing code associated with the service to requesting ones of the other nodes based on the set of policies.

17. The node of claim 12, further comprising a context manager registered with the management registry and adapted for managing communications with other managed peers in the networks, the communications comprising advertisements of services offered by the managed peers and changes to the set of policies.

18. A method for the global distribution and self-organization of intelligent, mobile agents, comprising:
instantiating a managed peer;
joining a place instance with the managed peer, the place instance defining an operating environment;
creating an agent implementing and executing domain logic for performing a task, the agent providing at least one mobile behavior;
monitoring the operating environment of the place instance; and
performing the at least one mobile behavior based on the monitored operating environment.

19. The method of claim 18, wherein the at least one mobile behavior comprises migration or replication.

20. The method of claim 18, wherein the agent creating comprises loading the place instance by the managed peer, loading an agent information instance containing information for declaratively defining and describing the agent, using the place instance to instantiate an agent manager, and creating the agent with the agent manager based on the agent information instance.

21. The method of claim 18, wherein the agent performs the task in a manner selected to suit the monitored operating environment.

22. The method of claim 18, wherein the performing of the at least one mobile behavior comprises maintaining a current state of the agent.

23. The method of claim 18, wherein the performing of the at least one mobile behavior comprises transferring agent code and agent state data.

24. The method of claim 18, further comprising performing monitoring, metering, and statistical analysis of the agent, and based on the performing, determining compliance with a set of policies and when determined non-compliant, making adjustments to the agent.

25. The method of claim 18, further comprising exposing the agent as a web service and registering the agent in a web services registry.

26. The method of claim 25, further comprising providing a persistent object containing information defining a WSDL-based definition of the agent as a web service and the agent comprises a WSDL document implementing the WSDL-based definition.

27. The method of claim 25, further comprising serving web application archives (WAR) files based on the agent and locating and requesting another agent comprising a web service in the web services registry.
